(19) United States
(12) Patent Application Publication
(10) Pub. No.: US 2026/0233831 A1
(43) Pub. Date: Aug. 13, 2026

(54) AIRCRAFT WHEEL BRAKING DEVICE

(71) Applicant: SAFRAN LANDING SYSTEMS, Velizy Villacoublay (FR)

(72) Inventors: Johan GIMENEZ, Moissy-Cramayel (FR); Sylvain MOLINE, Moissy-Cramayel (FR); Bruno ALDEBERT, Moissy-Cramayel (FR)

(73) Assignee: SAFRAN LANDING SYSTEMS, Velizy Villacoublay (FR)

(21) Appl. No.: 19/153,682

(22) PCT Filed: Feb. 5, 2024
(86) PCT No.: PCT/EP2024/052700

§ 371 Date: Aug. 5, 2025

(30) Foreign Application Priority Data
Feb. 8, 2023 (FR) FR 2301194

(51) Int. Cl. B64C 25/44; B60B 27/00; B64C 25/34; F16D 55/40

(52) U.S. Cl. CPC B64C 25/44; B64C 25/34; F16D 55/40; B60B 27/0052

(57) ABSTRACT

A braking device for an aircraft wheel includes a torque tube extending along a longitudinal axis, a stack of brake discs including a last stator disc, an actuator that includes a piston translatably mounted between a first end position in which the piston is spaced apart from the stack of discs and a second end position, to exert a pressing force on the first stator disc, and a stud arranged between a second end of the torque tube and the last stator disc in order to take up and transfer the pressing force to the torque tube. The last stator disc and the torque tube are shaped so as to define there between a minimum clearance which is less than the distance separating the piston from its second end position when said piston exerts the pressing force.

The invention relates to the field of aircraft wheel braking.

### BACKGROUND OF THE INVENTION

An aircraft wheel is conventionally rotatably mounted on an axle carried by a lower end of a landing gear leg. The aircraft wheel may be provided with a braking device to slow down and stop the aircraft when it is on the ground.

The braking device generally comprises a stack of discs comprising stator discs and rotor discs which are stacked alternately on a torque tube fixed to the axle. The stator discs are rotatably fixed relative to the axle and comprise a first stator disc and a last stator disc between which the rotor discs and the other stator discs extend. The rotor discs are rotatably connected to the wheel.

The braking device also comprises:
a hydraulic ring which is fixed to a first end of the torque tube and which comprises actuators provided with pistons arranged opposite the first stator disc for selectively exerting a pressing force on the stack of discs; and
studs arranged between the last stator disc and a second end of the torque tube in order to take up and transfer the pressing force to the torque tube.

The heat released as a result of friction between the discs can be significant (particularly during the landing of the aircraft where the energy to be dissipated is at its maximum because of the mass and the high speed of the aircraft) and can lead to axial creep of the studs, and therefore a displacement of the stack of discs that can cause the last stator disc to bear against the torque tube. The stroke of the pistons may then be insufficient to continue to exert a pressing force on the stack of discs, in particular when the discs are worn.

Consideration has been given to using actuators with a longer stroke. However such a solution is heavier and more cumbersome, and difficult to implement in an already defined and highly constrained environment.

Consideration has also been given to reducing the maximum permissible wear of the discs. However, this leads to more frequent disc changes and therefore a significant cost for the company operating the aircraft.

### Aim of the Invention

The invention therefore aims to propose an aircraft wheel braking device making it possible to at least partially prevent the above-mentioned problem.

### SUMMARY OF THE INVENTION

In order to achieve this aim, the invention provides a braking device of an aircraft wheel, comprising:
a torque tube extending along a longitudinal axis;
a stack of brake discs comprising stator discs and rotor discs stacked alternately on the torque tube, the stator discs comprising a first stator disc and a last stator disc between which intermediate stator discs are arranged alternately with the rotor discs;
at least one actuator that is fixed to a first end of the torque tube and which comprises a piston mounted so as to translatably move along an axis parallel to the longitudinal axis, between a first end position in which the piston is spaced apart from the stack of discs and a second end position, in order to exert a pressing force on the first stator disc; and
at least one stud arranged between a second end of the torque tube and the last stator disc in order to take up and transfer the pressing force to the torque tube.

According to the invention, the last stator disc and the torque tube are shaped to define between them, along the longitudinal axis, a minimum clearance which, for a given maximum wear of the discs, is less than the distance separating the piston from its second end position when said piston exerts the pressing force.

Thus, in the event of creep of the stud tending to bring the last stator disc to bear against the second end of the torque tube (in particular during emergency braking), the stroke of the piston remains sufficient for said piston to continue to exert the pressing force. It should be noted that such an adaptation of the last stator disc and/or of the torque tube does not impact the other components of the braking device.

According to a particular characteristic, the last stator disc comprises at least one boss extending in projection from a rear face of the last stator disc, the boss defining, with the torque tube, the minimum clearance.

According to a particular characteristic, the boss comprises a main face extending in a plane orthogonal to the longitudinal axis, the main face defining, with the torque tube, the minimum clearance.

In particular, the braking device comprises a plurality of studs equally distributed about the longitudinal axis, the last stator disc comprising a plurality of bosses each extending between two adjacent studs.

In particular, the bosses are in the shape of an arc of a circle and are inscribed in a circle whose centre belongs to the longitudinal axis.

According to another characteristic, the last stator disc comprises a rear face defining, with the torque tube, the minimum clearance.

According to another characteristic, the second end of the torque tube comprises at least one boss defining, with the torque tube, the minimum clearance.

The invention also relates to an aircraft wheel provided with such a braking device.

The invention also relates to an aircraft landing gear comprising at least one such wheel.

The invention further relates to an aircraft comprising at least one such landing gear.

### BRIEF DESCRIPTION OF THE DRAWINGS

The invention will be better understood in the light of the following description, which is purely illustrative and non-limiting, and should be read with reference to the accompanying drawings, in which:

FIG. 1 is a simplified representation of an aircraft comprising wheels equipped with a braking device according to a first embodiment of the invention;

FIG. 2 is an axial cross-sectional view of one of the braked wheels of the aircraft shown in FIG. 1;

FIG. 3A is a perspective view of the last stator disc of the braking device equipping the wheel shown in FIG. 2;

FIG. 3B is an axial cross-sectional view of the torque tube and the last stator disc shown in FIG. 3A;

FIG. 3C is a perspective view of a variant of the last stator disc shown in FIG. 3A;

FIG. 4A is an axial cross-sectional view of the last stator disc and the torque tube of a braking device according to a second embodiment of the invention;

FIG. 4B is an axial cross-sectional view of a first variant of the last stator disc shown in FIG. 4A,

FIG. 4C is an axial cross-sectional view of a second variant of the last stator disc shown in FIG. 4A;

FIG. 5 is an axial cross-sectional view of the last stator disc and the torque tube of a braking device according to a third embodiment of the invention.

### DETAILED DESCRIPTION OF THE INVENTION

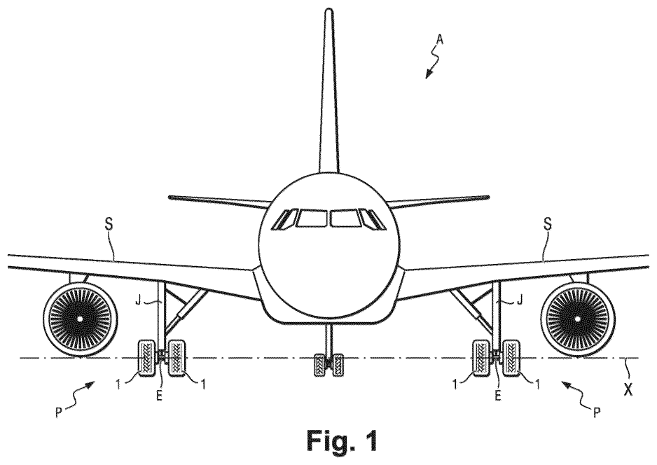

An aircraft A comprises, as shown in FIG. 1, two main landing gears P, each comprising a leg J having a first end hinged to a structure S of the aircraft A and, at the opposite end, a second end carrying wheels 1 rotating about an axis X on a tubular axle E. The leg J is movable between a retracted position (not shown) and a deployed position shown in this case.

The wheels 1 are said to be “braked”, i.e. provided with a braking device 10 intended to selectively slow down and stop the aircraft A when it is on the ground. The following description relates to one of the braked wheels 1, the braked wheels 1 of the aircraft A are in this case identical but can also be different.

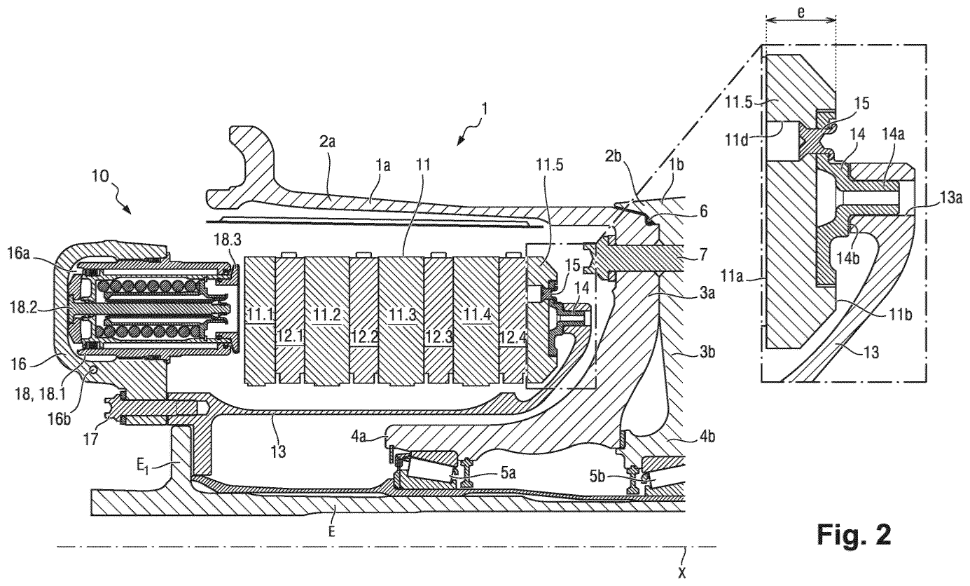

In reference to FIG. 2, the wheel 1 comprises two half-wheels 1a, 1b which each include an annular rim 2a, 2b connected by a web 3a, 3b to a half-hub 4a, 4b pivotally received on the axle E by means of bearings 5a, 5b. The half-wheel 1a includes a housing formed on an edge of the rim 2a and in which a sealing gasket 6 is arranged so that it becomes elastically compressed between the half-wheels 1a, 1b once they are assembled together.

The half-wheels 1a, 1b are moved towards each other in a direction parallel to the axis X of rotation of the wheel 1 and include centring surfaces to ensure the proper relative positioning of the two half-wheels 1a, 1b. The half-wheels 1a, 1b are held in position by assembly bolts 7 arranged in holes drilled opposite each other in the webs 3a, 3b.

The bolts 7 are screwed and tightened to assemble the half-wheels 1a, 1b after mounting a tire (not shown) on the rims 2a, 2b between the side walls thereof. In this position, the sealing gasket 6 is elastically compressed between the half-wheels 1a, 1b and thus prevents the gas contained in a volume delineated by the tire and the half-wheels 1a, 1b from escaping to the outside of the wheel 1.

In a manner known per se, the braking device 10 comprises carbon brake discs 11, including stator discs 11.1, 11.2, 11.3, 11.4, 11.5 and rotor discs 12.1, 12.2, 12.3, 12.4, which are stacked alternately against each other on a torque tube 13 fixed to a hand E1 of the axle E. The torque tube 13 and the stack of discs 11 extend inside the half-wheel la in an annular space delineated by an inside surface of the rim 2a, the web 3a and an outside surface of the half-hub 4a extending opposite the inside surface of the rim 2a.

The stator discs 11.1, 11.2, 11.3, 11.4, 11.5 comprise in particular a first stator disc 11.1 and a last stator disc 11.5 between which extend the rotor discs 12.1, 12.2, 12.3, 12.4 and the other stator discs 11.2, 11.3, 11.4 hereinafter referred to as “intermediate stator discs”.

The first stator disc 11.1 and the intermediate stator discs 11.2, 11.3, 11.4 comprise axial peripheral notches, each notch receiving a segment of a tenon (not shown) fixed to an outer surface of the torque tube 13. The tenons extend along an axis parallel to the axis X of rotation of the wheel 1 and ensure a rotational coupling of said first stator disc 11.1 and said intermediate stator discs 11.2, 11.3, 11.4 with the torque tube 13 about said axis X.

The last stator disc 11.5 comprises a friction front face 11a which faces the rotor disc 12.4, and a rear face 11b, opposite the front face 11a, which faces a first end of the torque tube 13 adjacent to the web 3a. The front face 11a and the rear face 11b each extend in a plane that is substantially orthogonal to the axis X and define a thickness e of the stator disc 11.5.

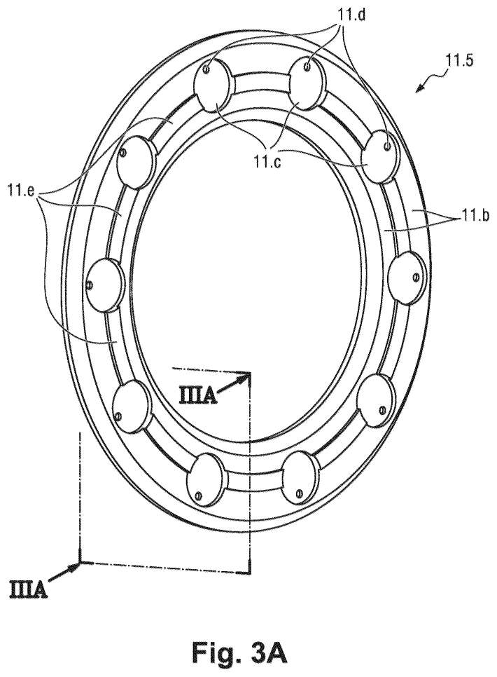

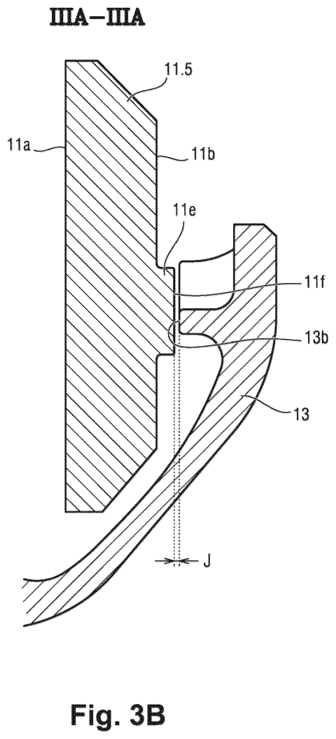

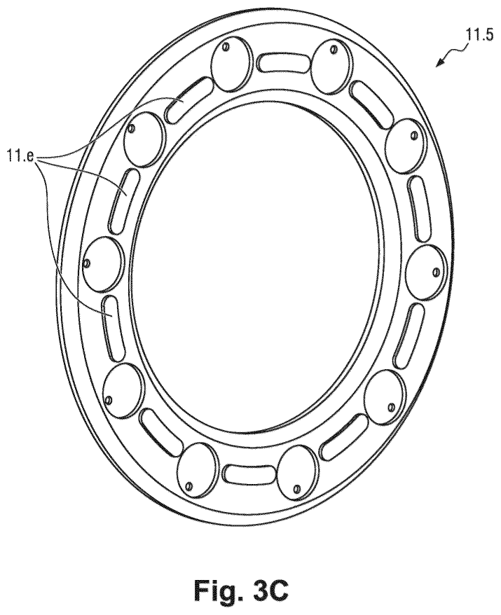

With reference to FIG. 3A, the rear face 11b of the last stator disc 11.5 includes a plurality of cylindrical recesses 11c which are evenly distributed about the axis X and in which are received studs 14, also called “pucks”, integral with the first end of the torque tube 13. The last stator disc 11.5 also includes bores 11d passing through it, each bore 11d comprising a conical shoulder and opening into one of the recesses 11c of the rear face 11b. A rivet 15 extending into each bore 11d makes it possible to fix each stud 14 to the last stator disc 11.5.

The studs 14 are identical and comprise a tubular end 14a extending along an axis parallel to the axis X, projecting from the rear face 11b of the last stator disc 11.5. The end 14a of each of the studs 14 is received in a bore 13a formed in the first end of the torque tube 13, so that said studs 14 ensure a rotational coupling of the last stator disc 11.5 with the torque tube 13 about the axis X. Furthermore, the end 14a of the studs 14 comprises a shoulder 14b bearing against a peripheral edge of the bore so as to take up and transfer, as will be seen later, pressing forces applied to the stack of discs 11 to the torque tube 13.

The rotor discs 12.1, 12.2, 12.3, 12.4 comprise axial peripheral notches, each notch receiving a segment of a bar (not shown) fixed to the inside surface of the rim 2a. The bars 14 extend along an axis parallel to the axis X of rotation of the wheel 1 and ensure a rotational coupling of the rotor discs 12.1, 12.2, 12.3, 12.4 with the rim 2a about said axis X.

The braking device 10 further comprises a hydraulic ring 16 fixed to a second end of the torque tube 13 by means of screws 17. The ring 16 comprises a plurality of cavities 16a equally distributed about the axis X of rotation of the wheel 1 and connected together by channels 16b. Each of the cavities 16a receives an actuator 18 selectively exerting, along an axis parallel to the axis X, a pressing force on the stack f discs 11 via a pressurised hydraulic fluid circulating inside the ring 16 through the channels 16b.

Each actuator 18 comprises a generally cylindrical sleeve 18.1 which is received in a sealed manner in the cavity 16a of the ring 16, and a piston 18.2 which is mounted in the sleeve 18.1 to slide along an axis parallel to the axis X of rotation of the wheel 1, between a first end position (shown in FIG. 2) in which the piston 18.2 is retracted into the sleeve 18.1, and a second end position (not shown) in which said piston 18.2 is extended from said sleeve 18.1. The first end position and the second end position define the stroke of the piston 18.2. One end of the piston 18.2 receives a pad 18.3 to push against a first stator disc 11a of the stack of discs 11. The equitable distribution of the actuators 18 about the axis X makes it possible to equally distribute the pressing forces exerted by the pistons 18.2 on the first stator disc 11.1 (via the pads 18.3).

The application of the pressing forces to the first stator disc 11.1 forces all of the discs 11 to rub against each other so that part of the kinetic energy of the aircraft A is dissipated as heat. The friction of the discs 11 causes wear of the various rubbing faces of the stator discs 11.1, 11.2, 11.3, 11.4, 11.5 and the rotor discs 12.1, 12.2, 12.3, 12.4, and therefore a reduction in their thickness.

According to a first embodiment of the braking device 10, the last stator disc 11.5 comprises, between each of the recesses 11c, a boss 11e in an arc of a circle projecting from the rear face 11b of said last stator disc 11.5 (FIGS. 3A and 3B). The bosses 11e extend from a recess 11c to an adjacent recess 11c and are inscribed here in a circle whose centre substantially belongs to the axis X. Each of the bosses 11e comprises a main face 11f which extends in a plane parallel to the rear face 11b and which is arranged to come to bear against an end face 13b of the torque tube 13 in the event of axial creep of the studs 14, in particular during emergency braking exerted by the actuators 18. The bosses 11e thus form pads making it possible to take up and transfer the pressing force to the torque tube 13 in the event of failure of the studs 14.

The main faces 11f of the bosses 11e and the end face 13b of the torque tube 13 are arranged to define a minimum clearance J, along the axis X, between the last stator disc 11.5 and the torque tube 13. The minimum clearance J is less, for a given maximum wear of the discs 11, than the distance between the pistons 18.2 of the actuators 18 from their second end position when said pistons 18.2 exert a pressing force on the first stator disc 11.1. Thus, in the event of axial creep of the studs 14 tending to move the stack of discs and bring the last stator disc 11.5 to bear against the end of the torque tube 13, the pistons 18.2 can continue to exert a pressing force on the stack of discs 11.

FIG. 3C shows a variant of the last stator disc 11.5 shown in FIG. 3A, in which the bosses 11e each extend between two adjacent recesses 11c and have semicircular ends.

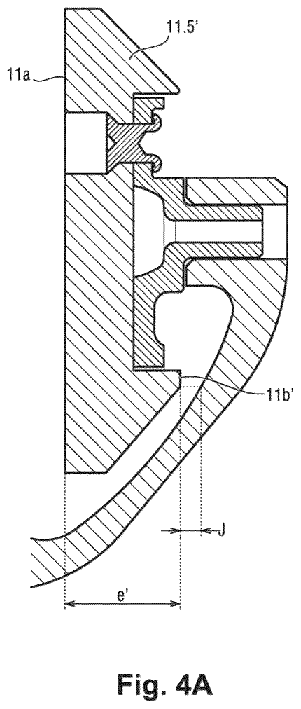

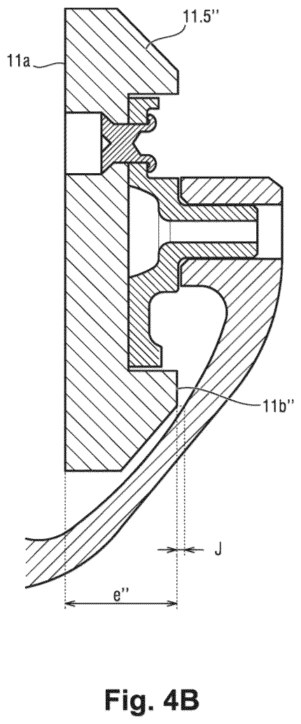

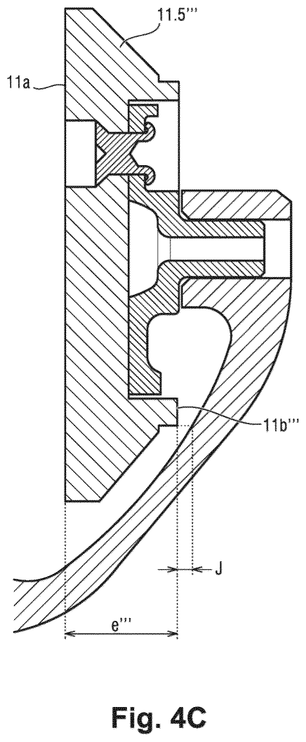

In a second embodiment of the braking device 10, the last stator disc 11.5 is replaced by a last stator disc 11.5′ shown in FIG. 4A. The last stator disc 11.5′ differs from the last stator disc 11.5 in that it has a rear face 11b ′ that has no boss. The rear face 11b′ and the front face 11a define a thickness e′ of the last stator disc 11.5′ which is greater than the thickness e of the last stator disc 11.5, the rear face 11b′ being arranged to define with the torque tube 13 the minimum clearance J. FIGS. 4B and 4C show last stator discs 11.5″, 11.5′″ corresponding to variants of the last stator disc 11.5′ shown in FIG. 4A. The last stator discs 11.5″, 11.5′″ differ from the last stator disc 11.5′ in that they comprise a rear face 11b′, 11b″′ defining with the front face 11a a thickness e″, e″′ of said last stator discs 11.5″, 11.5′″ which is different from the thickness e′ of the last stator disc 11.5′. The thickness e″, e″′ of the last stator discs 11.5″, 11.5′″ is greater than the thickness e of the last stator disc 11.5 and the rear faces 11b″, 11b′″ are arranged to define with the torque tube 13 the minimum clearance J.

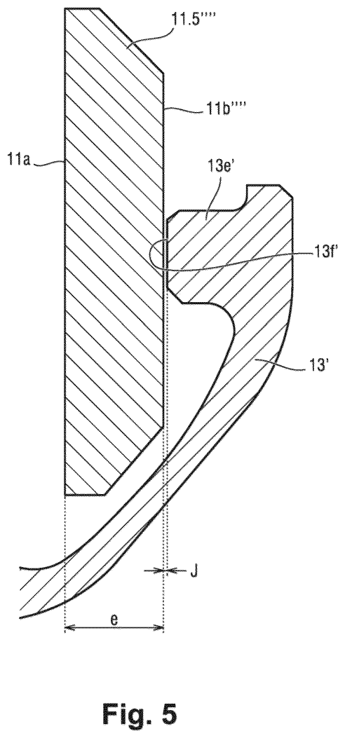

According to a third embodiment of the braking device 10, the last stator disc 11.5 is replaced by a last stator disc 11.5″″ shown in FIG. 5, and the torque tube 13 is replaced by a torque tube 13′. The last stator disc 11.5″″ differs from the last stator disc 11.5 in that it has a rear face 11b″″ that has no boss. The rear face 11b″″ and the front face 11a define a thickness of the last stator disc 11.5″″ which is equal to the thickness e of the last stator disc 11.5. The torque tube 13′ differs from the torque tube 13 in that its first end is provided with bosses 13e′ extending opposite the rear face 11b″″ of the last stator disc 11.5″″. Each of the bosses 13e′ extends between two adjacent studs 14 and comprises a main surface 13f′ which extends in a plane parallel to the rear face 11b″″ of the last stator disc 11.5″″ and which is arranged to come to bear against said rear face 11b″″ in the event of axial creep of the studs 14. The bosses 13e′ thus form pads making it possible to take up and transfer the pressing force to the torque tube 13′ in the event of failure of the studs 14. The main surfaces 13f′ of the bosses 13e′ are arranged to define with the rear face 11b″″ of the last stator disc 11.5″″ the minimum clearance J.

Naturally, the invention is not limited to the embodiments described, but encompasses any variant falling within the scope of the invention such as defined by the claims.

The rim can be made up or one or more pieces.

The number of stator discs and the number of rotor discs may be different from those shown.

The number, the shape and the location of the studs 14 can be different from those shown.

The number of actuators 18 can be equal to the number of studs 14 or different from said number of studs 14.

The number, the shape and the location of the bosses 11e can be different from those shown.

Although the actuators in this case are hydraulic, they can also be electric.

Although the bosses 11e, 13e′ in this case are made in one piece with the last stator disc 11.5, 11.5″″ and the torque tube 13, 13′, they can also be added.

Although the brake discs in this case are made of carbon, the bosses 11e, 13e′ can be made of other materials such as steel, titanium, nickel/chromium/iron alloys such as those of the Inconel brand, a polymer such a polyetheretherketone (PEEK), a ceramic, etc.

1. A braking device for an aircraft wheel, the braking device comprising:
a torque tube extending along a longitudinal axis;
a stack of brake discs comprising stator discs and rotor discs stacked alternately on the torque tube, the stator discs comprising a first stator disc and a last stator disc, between which intermediate stator discs are arranged alternately with the rotor discs;
at least one actuator that is fixed to a first end of the torque tube and which comprises a piston mounted so as to translatably move along an axis parallel to the longitudinal axis, between a first end position in which the piston is spaced apart from the stack of discs and a second end position, in order to exert a pressing force on the first stator disc; and
at least one stud arranged between a second end of the torque tube and the last stator disc in order to take up and transfer the pressing force to the torque tube;
wherein the last stator disc and the torque tube are shaped to define between them, along the longitudinal axis, a minimum clearance which, for a given maximum wear of the discs, is less than the distance separating the piston from its second end position when said piston exerts the pressing force, and
wherein the last stator disc or the second end of the torque tube comprises at least one boss defining, respectively with the torque tube or the last stator disc, the minimum clearance.

2. (canceled)

3. The braking device according to claim 1, wherein the boss of the last stator disc comprises a main face extending in a plane orthogonal to the longitudinal axis, the main face defining, with the torque tube the minimum clearance.

4. The braking device according to claim 1, comprising a plurality of studs equally distributed about the longitudinal axis, the last stator disc comprising a plurality of bosses each extending between two adjacent studs.

5. The braking device according to claim 4, wherein the plurality of bosses are in the form of an arc of a circle and are inscribed in a circle whose centre belongs to the longitudinal axis.

6. (canceled)

7. (canceled)

8. An aircraft wheel provided with a the braking device according to claim 1.

9. An aircraft landing gear comprising at least one of the aircraft wheel according to claim 8.

10. An aircraft comprising at least one of the landing gear according to claim 9.

11. The braking device according to claim 3, comprising a plurality of studs equally distributed about the longitudinal axis, the last stator disc comprising a plurality of bosses each extending between two adjacent studs.
